(19) United States
(12) Patent Application Publication
(10) Pub. No.: US 2010/0245316 A1
(43) Pub. Date: Sep. 30, 2010

(54) LIQUID CRYSTAL DISPLAY AND DRIVING METHOD THEREOF

(75) Inventor: CHIEN-YUNG CHENG, Taipei City (TW)

Correspondence Address: STOUT, UXA, BUYAN & MULLINS LLP, 4 VENTURE, SUITE 300, IRVINE, CA, 92618, US

(73) Assignee: HANNSTAR DISPLAY CORP., Taipei City (TW)

(21) Appl. No.: 12/482,425

(22) Filed: Jun. 10, 2009

(30) Foreign Application Priority Data
Mar. 27, 2009 (TW) 098110246

(51) Int. Cl. G09G 5/00

(52) U.S. Cl. 345/211

(57) ABSTRACT

The embodiments of the present invention disclose a Liquid Crystal Display (LCD) having a low power consumption. Under normal operation of the LCD, a plurality of data voltages are inputted to a display panel having a constant frame rate, and an idle detecting step is performed to determine whether to change the frame rate. When a percentage of the plurality of data voltages is not varied for a specific period of time, the frame rate is reduced.

### CROSS-REFERENCE

The entire contents of Taiwan Patent Application No. 098110246, filed Mar. 27, 2009, from which this application claims priority, is incorporated herein by reference.

### FIELD OF THE INVENTION

The present invention relates to a Liquid Crystal Display, and more particularly, to a Liquid Crystal Display capable of lowering power consumption under normal operation.

### DESCRIPTION OF THE PRIOR ART

Lowering power consumption is always an important issue for Liquid Crystal Displays (LCDs), such as LCD television, LCD monitor, digital photo frame, and the like devices. Power-conserving methods may comprise turning off power to the screen, backlight module, and idle devices of the LCD.

Altering the driving method or driving structure of LCDs may also achieve the purpose of low power consumption. FIG. 1 shows a conventional driving structure of a LCD, which comprises a display panel 10 having a pixel array, a gate driver 12 for driving gate lines G0-Gn, a data driver 14 for driving data lines D1-Dm, and a timing controller 16 for driving the gate driver 12 and the data driver 14. In addition, each pixel of the pixel array comprises a transistor 18, a storage capacitor Cₛₜ, and a liquid crystal capacitor C_{LC}.

Various power-conserving methods that alter the driving method or driving structure of the LCD may be practicable, but the power consumption for each is still high when the LCD is in a non-power-conserving mode, i.e., under normal operation. For example, the LCD typically has a constant frame rate under normal operation. The frame rate is typically indicated in fps (frames per second) or Hz (hertz); in general, the LCD typically has a constant frame rate of 60 Hz or 180 Hz. FIG. 2 illustrates two data voltages having different polarity being written to two pixels for displaying a frame. Under normal operation, gate line G0 provides a voltage to open a transistor 18, so that a positive or a negative data voltage is written to a pixel of a specific position via a data line. For example, a positive data voltage is written to the left pixel via the data line D1, and a negative data voltage is written to the right pixel via the data line D2 as shown in FIG. 2. The value of the voltage written to the pixel depends on the video content of the frame. If a LCD has a constant frame rate at 60 Hz, the period of one frame will be 1/60=16.67 ms. Hence, each pixel of each row of the pixel array must be charged once per 16.67 ms, and each pixel must be charged 60 times per second. The charging frequency is high, and the written data voltages cannot be altered because it relates to the video content of the frame; therefore, the power consumption is high when the LCD is under normal operation according to the prior art.

Therefore, it would be advantageous to provide a better power-conserving method and device to improve the deficiencies of the prior art.

### SUMMARY OF THE INVENTION

The object of the present invention is to provide a better power-conserving method and device that is capable of lowering power consumption under normal operation.

According to the object, the embodiments of the present invention provide a Liquid Crystal Display (LCD) and its driving method. The LCD comprises a display panel and a timing controller, the timing controller controlling the display panel and executing the driving method. The method comprises a step of executing a normal operation, which comprises the processor outputting a plurality of control signals to a data driver, the data driver outputting a plurality of data voltages to the display panel via a plurality of data lines, and the LCD being displayed at a constant initial frame rate. The method further comprises a step of executing one or more of (a) an idle detecting step to determine whether an idle event is met and (b) a first manipulation detecting step to determine whether a manipulation event is met, whereby the initial frame rate is decreased to a first frame rate when a reference percentage or more of the plurality of data voltages are unchanged after a period of time or when a manipulation event (e.g., that selects a specific display mode) is met.

### BRIEF DESCRIPTION OF THE DRAWINGS

FIG. 1 shows a conventional driving structure for a Liquid Crystal Display (LCD) according to the prior art.

FIG. 2 illustrates two data voltages having different polarity being written to two pixels for displaying a frame according to the prior art.

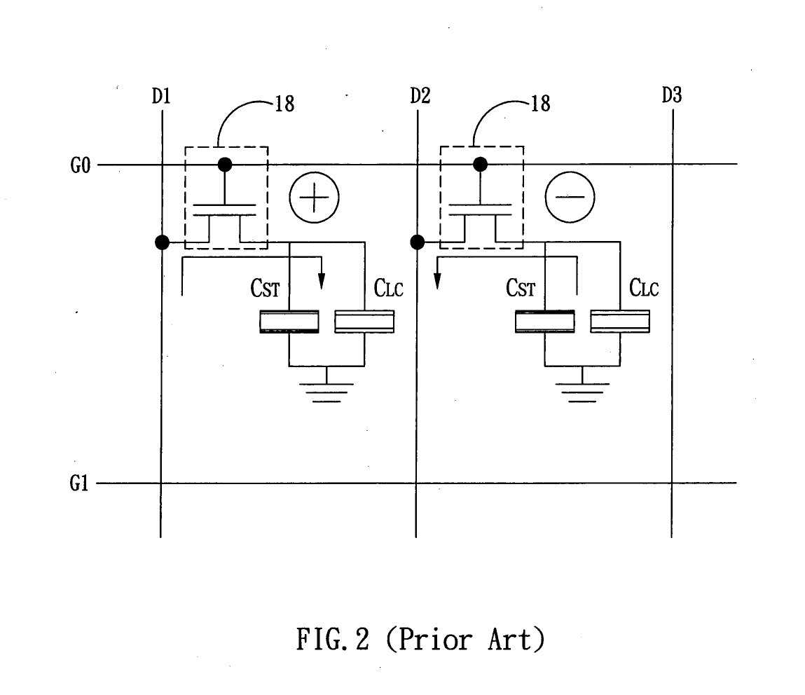

FIG. 3 discloses a driving method for operating a LCD according to an embodiment of the present invention.

FIG. 4 shows a driving method according to another embodiment of the present invention.

FIG. 5 shows a driving method according to another embodiment of the present invention.

FIG. 6 illustrates operation of the driving method according to an embodiment of the present invention.

FIG. 7 shows a block diagram of a LCD according to one embodiment of the present invention.

FIG. 8 shows a LCD according to another embodiment of the present invention.

FIG. 9 shows how decreasing the frame rate, as in FIGS. 7 and 8, results in the frequency of the control signal being decreased as well.

FIG. 10 and FIG. 11 illustrate decreases in frame rate, and adapted adjustments of the control signal, according to two embodiments of the present invention.

### DESCRIPTION OF THE PREFERRED EMBODIMENT

Reference will now be made in detail to specific embodiments of the invention. Examples of these embodiments are illustrated in the accompanying drawings. While the invention will be described in conjunction with these specific embodiments, it will be understood that such is not intended to limit the invention to these embodiments. On the contrary, it is intended to cover alternatives, modifications, and equivalents as may be included within the spirit and scope of the invention as defined by the appended claims. In the following description, numerous specific details are set forth in order to provide a through understanding of the present invention. The present invention may be practiced without some or all of these specific details. In other instances, well-known process operations are not described in detail in order not to unnecessarily obscure the present invention. While drawings may be illustrated in detail, it is appreciated that the quantity of the disclosed components may be greater or less than that disclosed, except for instances expressly restricting the amount of the components. Wherever possible, the same or similar reference numbers are used in the drawings and description to refer to the same or like parts.

Displaying the video signal with a high frame rate is increasingly necessary for present displays such as modern Liquid Crystal Displays (LCDs). The inventor of the present invention has observed, however, that a lower frame rate can be satisfactory in some situations under normal operation, whereby the constant high frame rate may be unnecessary.

Accordingly, the present invention discloses methods and devices that are capable of dynamically changing the frame rate. In particular, the frame rate can be changed according to the video content or the user's operation; hence, the objective of low power consumption can be achieved.

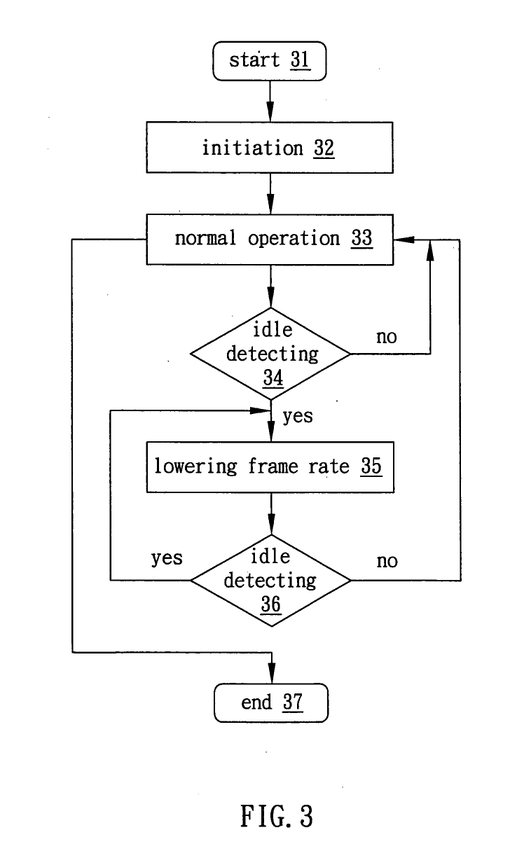

FIG. 3 discloses a driving method for a LCD according to an embodiment of the present invention. The LCD comprises a processor (not shown) for outputting control signals and controlling the frame rate. The processor executes the driving method for determining opportunities (e.g., times) that the frame rate can or will be changed. At step 31 the method begins, and at step 32 the LCD is initiated. For example, but not by way of limitation, before the normal operation an Optically Compensated Birefringence LCD must transform some of the liquid crystal molecules from the splay state to the bend state at the initiation step. At step 33, a normal operation is started. In this step, the LCD may be displayed at a constant frame rate, for example, at a predetermined initial frame rate of 60 Hz or 120 Hz. At step 34, an “idle detecting” step is performed to check or determine whether an “idle” event has occurred, wherein the idle is defined as an event when a percentage (e.g., a reference percentage; e.g., 55%) or more of the plurality of data voltages written to the pixel array by the plurality of data lines is unchanged after a predetermined or automatically set up period of time. For, example, a LCD has 1024×768 pixels, therefore having 1024×3=3072 data lines. Under the normal operation, if 1689 data voltages (about 55% of 3072) of the 3072 data voltages are unchanged after a period of time T, an idle event is met. According to the embodiment of the present invention, the period of time T is longer than the period of one frame. Preferably, the period of time T may range from 1 to 5 seconds, but according to a feature of the invention this range is not intended to be limiting. At step 35, if an idle event is met, the initial frame rate is decreased to a first frame rate to lower the power consumption. If an idle event is not met, the frame rate is kept the same as the initial frame rate. At step 36, the “idle detecting” step is performed again to check or determine whether another “idle” event has occurred. If another idle event is met, the first frame rate may be changed to a second frame rate, wherein the second frame rate may be equal to, larger than, or smaller than the first frame rate according to the extent of the idle and/or according to the video content. That is, if the current video content needs a higher frame rate, the second frame rate may be larger than the first frame rate. If a lower frame rate satisfies the current video content, the second frame rate may be smaller than the first frame rate. If another idle event is not met, processing may return back to the normal operation 33, whereby the frame rate is increased to the initial frame rate. At step 37, the driving method ends. Typically the driving method is concluded by receiving an ending demand at the normal operation 33, but such event should not be interpreted to be limiting.

In the above-mentioned steps, the initial frame rate may be decreased to the first frame rate or even decreased to the second frame rate. The values of the first frame rate and the second frame rate are not intended to be limited, and, for example, they may be minimized to meet a condition of the LCD having no flicker; otherwise the viewer will be aware it. Hence, the frame rate may be decreased to a lower limit value that is the minimized value under the condition that the LCD has no flicker. The lower limit value can be chosen with regard to or in connection with the manufacturing method, process capability, and kind of LCD. In addition, according to one embodiment, the idle reference percentage of the plurality of data voltages is preferably defined as 50%, 55%, or more, of the data voltages.

Many situations may satisfy or be taken into account to satisfy the idle event. For example, when the LCD is employed in a department store for displaying an advertisement, the update frequency of the image of the advertisement may be low. Hence, the frame rate may be decreased when the advertisement is being displayed and an idle event is met. For example, when the LCD is employed for displaying television news, the lips of the anchor may be the only varied portion of the television news in a period of time; therefore, this situation may satisfy the definition of an idle event. As another example, when the LCD is employed as a photo digital frame, the update frequency for the photo may be low, and the period of time when the current photo is not changed will likely (e.g., with a high probability) meet the definition of an idle event. To summarize this aspect, the inventive concept of the embodiments of the present invention is to determine whether the frame rate is or is to be changed according to whether the current video content meets the definition of an idle event.

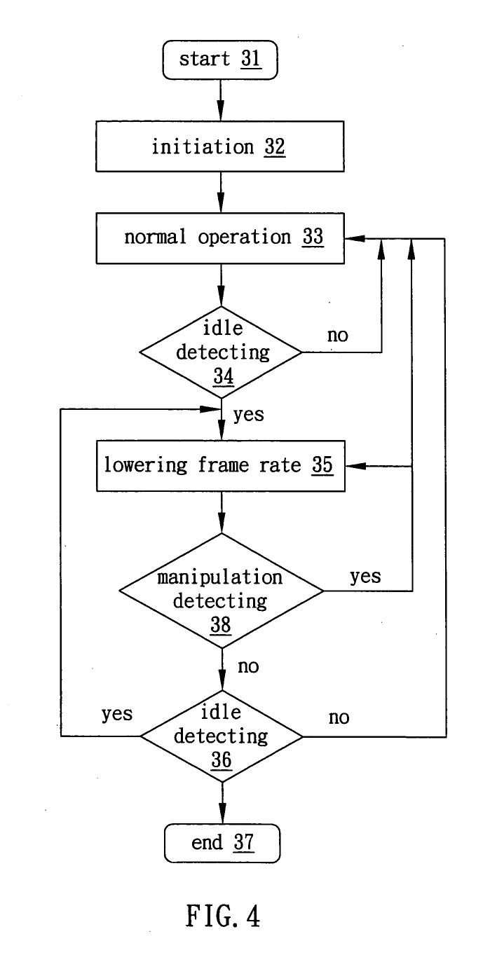

FIG. 4 shows a driving method according to another embodiment of the present invention. This embodiment is a modification of the embodiment shown in FIG. 3; the difference is that the driving method further comprises a “manipulation detecting” step 38 before the idle detecting step 36. The manipulation detecting step 38 checks or determines whether a manipulation event is induced by the user. If a manipulation event is met, then processing returns back to step 35 or step 33 according to the manipulation event. If a manipulation event is not met, then performance of the idle detecting step 36 occurs. This embodiment may be applied to a LCD having a variant manipulative display mode, such as photo mode, video mode, MP3 mode, TV game mode, and the like. Each display mode may correspond to a predetermined frame rate, and these frame rates may be equal to or smaller than the frame rate under normal operation, i.e., the initial frame rate. Therefore, when the user selects a display mode the current frame rate will be changed to the initial frame rate (step 33) or kept at a lower frame rate (step 35) according to the video content of the display mode that the user selected. In another embodiment, when the user selects a display mode, the current frame rate will be changed to the initial frame rate (step 33) or kept at a lower frame rate (step 35) according to the display mode that the user selected. In another embodiment of the present invention, if a manipulation event is met, then the method returns back to the normal operation at step 33 and the frame rate is dominated by the user. For example, the user may select a specific display mode and determine a specific frame rate or the display may actively adopt a specific frame rate which is set up inside the display mode. When the user controls the frame rate, steps 34, 35, 36, and 37 may be held in a standby state until, for example, (a) a predetermined time has passed without further action by the user or (b) occurrence of a demand/request is actively made by the user for the idle detecting step 34 to be restarted. Additionally, or alternatively, the embodiment of FIG. 4 may omit the idle detecting step 36; in this case, when a manipulation event is not evidenced, the LCD will display at the first frame rate or the second frame rate until the process end 37.

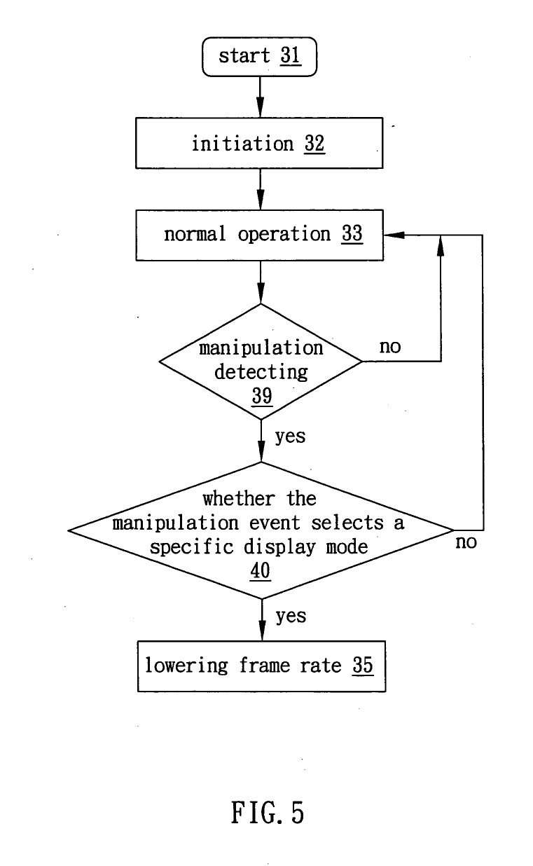

FIG. 5 shows another embodiment of the present invention in which a manipulation detecting step 39 and a “whether the manipulation event selects a specific display mode” step 40 have replaced the idle detecting step 34 mentioned above. In this embodiment, the steps after the “lowering frame rate” step 35 may be the same as those of the embodiment of FIG. 3, FIG. 4, and/or modifications of them; therefore, the description is omitted for simplicity. At step 39, occurrence or detection of a manipulation event under the normal operation 33 indicates that the user may select a display mode. At step 40, the processor checks or determines whether the manipulation event is a specific display mode. The specific display mode is defined as the video content which can be displayed in a lower frame rate, such as the photo mode and the MP3 mode. If the user selects one specific display mode, then the step 35 “lowering frame rate” is performed; otherwise processing returns back to normal operation 33. It is appreciated that the “manipulation detecting” steps 38 and 39 of FIGS. 4 and 5 are not limited in/to situations where the user selects or alters the display mode; any event induced by the user, for example, in an embodiment, touching the screen of the display and/or pressing a specific key, may correspond to specify a frame rate, respectively, followed by the processor changing the frame rate accordingly.

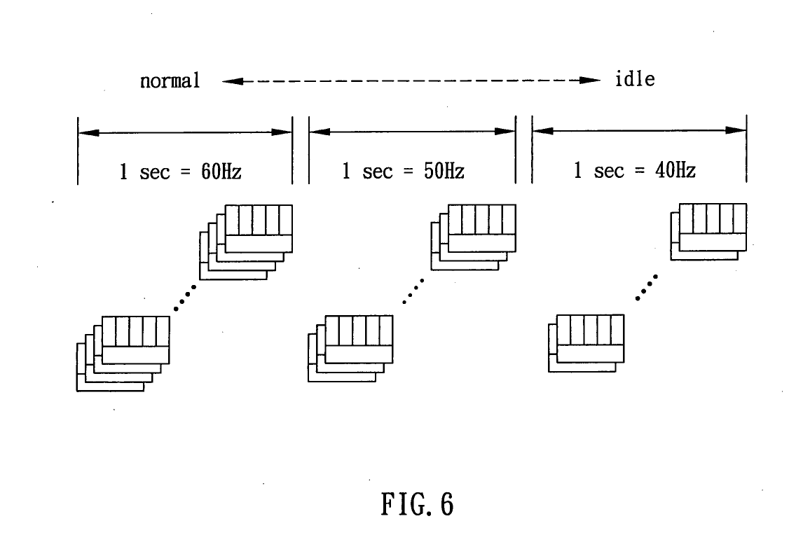

FIG. 6 illustrates the operation of the driving method according to an embodiment of the present invention. This exemplary embodiment is shown for purposes of illustration; it should not be limited. Under the normal operation, the frame rate of a given LCD may be fixed at 60 Hz. When the current video content satisfies the definition of an idle event, the frame rate may be lowered to 50 Hz or 40 Hz; when a higher frame rate is necessary for the current video content, the frame rate is increased (e.g., back to the normal operation). According to the driving method of the present invention, the frame rate can be dynamically decreased, along with the charging frequency (no matter positive or negative voltage) of liquid crystal capacitor C_{LC} and thus the power consumption being decreased as well.

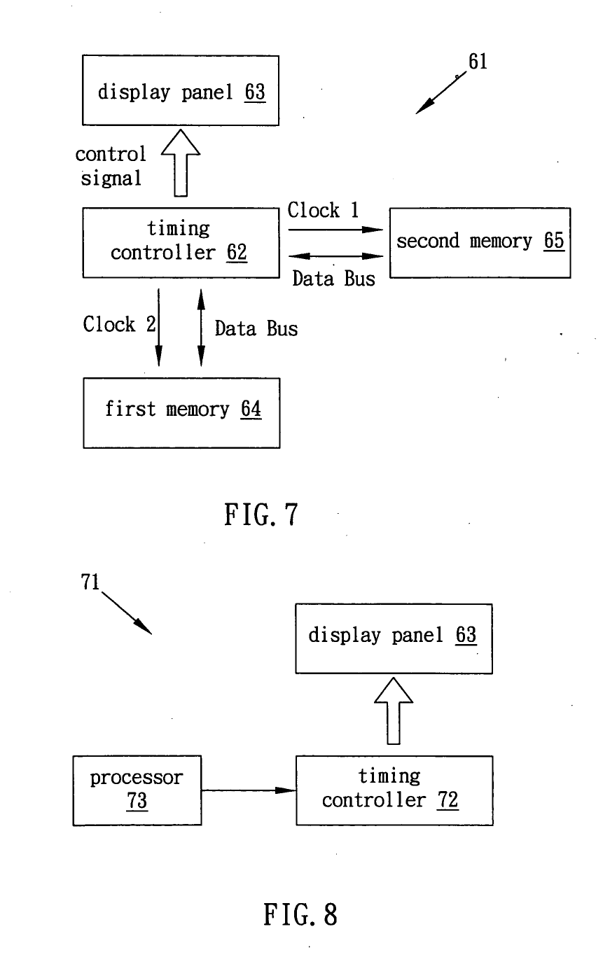

FIG. 7 shows a block diagram of a LCD according to an embodiment of the present invention. The LCD 61 comprises a timing controller 62, a display panel 63, a first memory 64, and a second memory 65. The first memory 64 and the second memory 65 are employed for storing image data. In one embodiment, the first memory 64 comprises a NAND flash memory, and the second memory comprises a Synchronous Dynamic Random Access Memory (SDRAM). The timing controller 62 may correspond to the processor as mentioned in connection with the description of FIG. 3; it is employed for executing the driving method of the present invention and outputting a control signal for controlling the display panel 63. The timing controller 62 respectively accesses image data via Clock 1, Clock 2, and Data Bus. It is appreciated that while this exemplary embodiment includes two memories, it should not be limited to such. In another embodiment, the LCD may comprise only one memory, for example, only a SDRAM, and the timing controller 62 accesses the image data from the SDRAM. In another embodiment, the LCD may connect to an external data-storing device, such as a DVD-ROM, and access image data from the external data-storing device. According to the driving method of embodiments of the present invention, the frame rate can be dynamically adjusted. Decreasing of the frame rate corresponds to the updating frequency of the plurality of data voltages of the data lines being decreased as well; therefore, the accessing frequency of the timing controller 66 accessing the memory or external data-storing device through the signal Clock 1, Clock 2, and Data Bus can be decreased as well. Hence, the power consumption for accessing the image data can also be correspondingly decreased, thus meeting the objective of low power consumption.

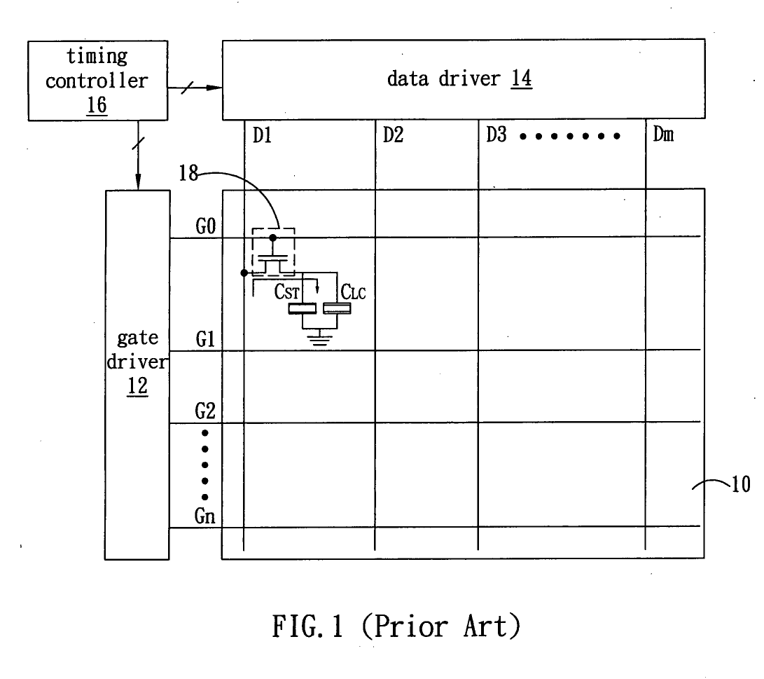

In addition, the timing controller 62 may control the display panel 63 by any well-known method, such as by the method described in connection with FIG. 1. For example, the timing controller 62 outputs control signals to a gate driver and a data driver for controlling the display panel 63. The gate driver and source driver may comprise a plurality of gate driving chips and a plurality of data driving chips respectively. In another embodiment of the present invention, the timing controller 62 may provide a control signal to the source driver only, followed by the source driver outputting a control signal to the gate driver. In another embodiment, the driving system comprises two gate drivers; that is, a double gate driver design is also acceptable in the present invention.

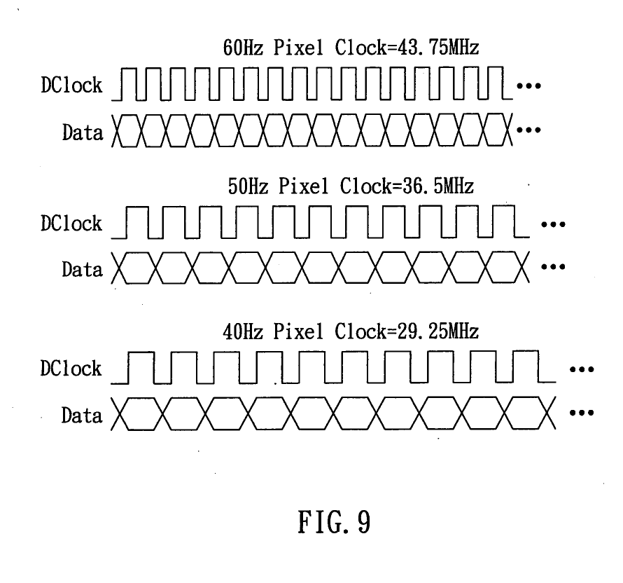

FIG. 8 shows a LCD according to another embodiment of the present invention. This embodiment differs from the embodiment of FIG. 7 in that the duties of the first memory 64 and the second memory 65 are incorporated into a timing controller 72 or a processor 73, and the processor 73 is responsible for executing the driving method of the present invention and controlling the display panel 63 by way of the timing controller 72. Although variant modifications are and can be adapted in the present invention, the principle of/for lowering the power consumption is the same. As with the embodiments described above, the timing controller, the independent processor, and/or any other controllers of the display may individually or in combination execute the driving method of the present invention.

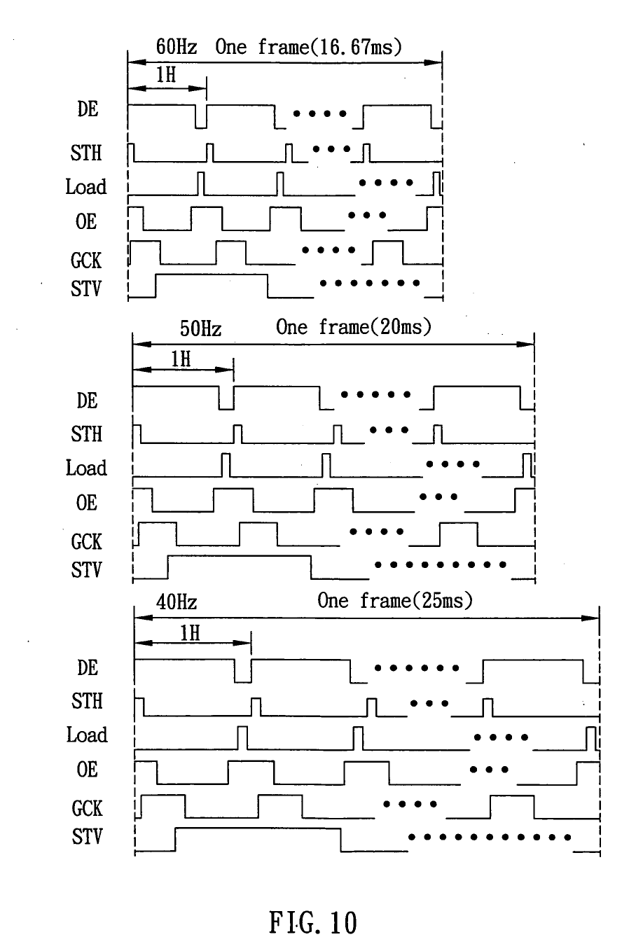

FIG. 9 shows the frequency of the control signal being decreased as well when the frame rate is decreased as in FIG. 7 or FIG. 8. In other words, the charging frequency of liquid crystal capacitor C_{LC} is also decreased, corresponding to the charging number(s) being reduced in a given (e.g., same) period of time, resulting in lower power consumption. For example, suppose that one LCD has 1024×600 pixels, the frame rate is 60 Hz, and the frequency of the Driving Clock (DClock) and Data are 43.75 MHz. When the frame rate is decreased to 50 Hz, the frequency of the DClock and Data are adaptively decreased in the example to 36.5 MHz. Because the frame rate is decreased, the updating frequency of the DClock and Data does not need to be maintained at the high frequency, so that in the example the frequency is decreased from 43.75 MHz to 36.5 MHz, and therefore the frequency of Clock 1 and Clock 2 shown in FIG. 7 may be decreased in a corresponding manner. Accordingly, the power consumption of the accessing activities can be significantly reduced. Similarly, when the frame rate is decreased to 40 Hz, the DClock and Data are adaptively decreased in the example to 29.25 MHz, and the control signal Clock 1/Clock 2 (as shown in FIG. 7) can be adaptively decreased, as well, for lower power consumption.

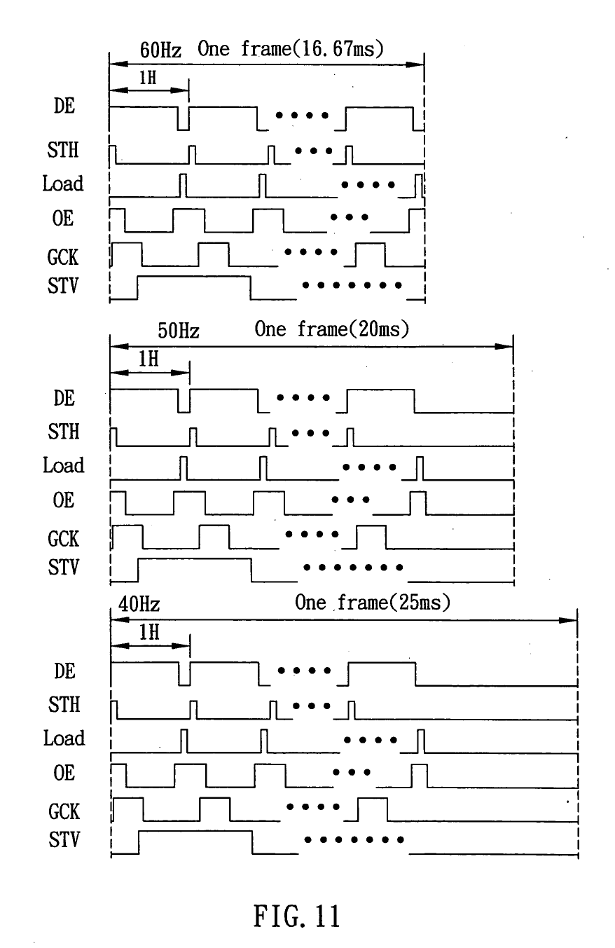

FIG. 10 and FIG. 11 illustrate details of the frame rate being decreased, and the adapted adjustments of the control signal, according to two embodiments of the present invention. These two figures illustrate how the charging frequency of the liquid crystal capacitor C_{LC} is affected by the driving method of the present invention. Generally, the control signals for controlling the display panel are divided into gate control signals and source control signals. The gate control signals may comprise, but are not limited to, Gate Driver Start Signal (STV), Gate Clock Signal (GCK), and Gate Driver Output Enable Signal (OE). The source control signals may comprise Source Driver Start Signal (STH), Data Enable Signal (DE), and Load Signal (Load). Other signals not being shown may comprise Data Clock Signal (having same waveform as the DE signal) and Polarity Control Signal. The functions of the above control signals are well known in the field of display devices and thus are omitted from this description for simplicity. FIG. 10 shows the additional adaptive adjustment of the data control signals and the source control signals in addition to the frequency change shown in FIG. 9. As elucidated in FIG. 10, each control signal includes a predetermined number of activity periods (an activity period is denoted by 1H) during one frame, wherein one activity period may comprise a pull high event and a pull low event. According to the embodiment of FIG. 10, when frame rate is decreased, the period of one frame is adaptively increased, the period of one frame being increased, for example, from 16.67 ms to 20 ms or 25 ms; however, the number of activity periods during one frame, i.e., the charging numbers of the liquid crystal capacitor C_{LC} during one frame, is not altered. As an example, for frame rates of 60 Hz, 50 Hz, and 40 Hz, a same control signal includes a same predetermined number of activity periods during one frame. In addition, because the predetermined activity periods are evenly distributed in one frame according to the embodiment of FIG. 10, the period of each activity period is adaptively increased; for example, the activity period at the frame rate of 50 Hz or 40 Hz is longer than that at the frame rate of 60 Hz. The period of each activity period being increased means that the charging time is adaptively increased, i.e., the charging frequency is decreased during a same period of time, in accordance with the objective of low power consumption. In other words, the principle embodiment of FIG. 10 is that when the period of one frame is increased in response to the frame rate being decreased, the period of one activity period of each control signal is increased, i.e., the charging time of the liquid crystal capacitor is increased, but the number of the activity periods during one frame is not altered, so as to meet the objective of low power consumption.

Referring to FIG. 11, the adaptive adjustment of the control signals according to another embodiment of the present invention is shown. In this embodiment, when the period of one frame is increased in response to the frame rate being decreased, neither the length (i.e., period) of one activity period of each control signal nor the number of the activity periods of one frame is altered, and after all the activity periods are completed the control signals are kept inactive until the end of the current frame. For example, when the frame rate is decreased from 60 Hz to 50 Hz or 40 Hz, the period of one frame is increased to 20 ms or 25 ms. Here, the length of the activity period (1H) of the frame rate 50 Hz and 40 Hz is the same as for the frame rate 60 Hz for the same control signal (such as DE), the number of the activity periods of one frame is not altered, and after all the activity periods are completed the control signals are kept inactive, i.e., “signal low,” until the end of the current frame. Accordingly, the average power consumption of the lower frame rate (such as 40 Hz or 50 Hz) is lower than that of the unchanged frame rate (such as 60 Hz), in accordance with the objective of low power consumption.

As a consequence of the driving method and LCD of the present invention, the frame rate of the LCD can be dynamically changed under the normal operation. In addition, incorporating other power-conserving methods as well known may further decrease the power consumption.

Although specific embodiments have been illustrated and described, it will be appreciated by those skilled in the art that various modifications may be made without departing from the scope of the present invention, which is intended to be limited solely by the appended claims.

What is claimed is:

1. A driving method for a Liquid Crystal Display (LCD), the LCD comprising a processor and a display panel with said processor controlling said display panel, the method comprising:
executing a normal operation characterized by said processor outputting a plurality of control signals to a data driver, said data driver outputting a plurality of data voltages to said display panel via a plurality of data lines, and said LCD displaying at a constant initial frame rate;
executing one or more of (a) an idle detecting step to determine whether an idle event is met and (b) a first manipulation detecting step to determine whether a manipulation event is met; and
decreasing the initial frame rate to a first frame rate, when a reference percentage or more of the plurality of data voltages are unchanged after a period of time or upon occurrence of a manipulation event that selects a specific display mode.

2. The driving method as recited in claim 1, wherein the reference percentage is defined as 50% or more of the plurality of data voltages.

3. The driving method as recited in claim 1, wherein, after the initial frame rate is decreased to the first frame rate, the idle detecting step is performed again to determine whether the idle event is met, whereby:
when the reference percentage or more of the plurality of data voltages are unchanged after the period of time, the first frame rate is decreased to a second frame rate; and
when the reference percentage or more of the plurality of data voltages are changed after the period of time, the first frame rate is increased to the initial frame rate.

4. The driving method as recited in claim 3, wherein the second frame rate is smaller than the first frame rate, and both the first and second frame rates are smaller than the initial frame rate.

5. The driving method as recited in claim 3, wherein the second frame rate is larger than the first frame rate, and both the first and second frame rates are smaller than the initial frame rate.

6. The driving method as recited in claim 3, wherein the second frame rate is equal to the first frame rate, and both the first and second frame rates are smaller than the initial frame rate.

7. The driving method as recited in claim 6, wherein the first frame rate and the second frame rate have a lower limit value that is the minimal value required for the LCD to operate without flicker.

8. The driving method as recited in claim 1, wherein, after the frame rate is decreased to the first frame rate, a second manipulation detecting step is performed to determine whether a manipulation event is met, whereby when the manipulation event is met the first frame rate is recovered to the initial frame rate or decreased to a second frame rate according to the manipulation event, with the second frame rate being larger than, smaller than, or equal to the first frame rate.

9. The driving method as recited in claim 8, whereby, when the manipulation event is not met the idle detecting step is performed again, characterized in that:
when the reference percentage or more of the plurality of data voltages are unchanged after the period of time, the first frame rate is decreased to the second frame rate; and
when the reference percentage or more of the plurality of data voltages are changed after the period of time, the first frame rate is increased to the initial frame rate.

10. The driving method as recited in claim 1, wherein:
said processor further outputs a plurality of control signals to a gate driver; and
when the reference percentage or more of the plurality of data voltages are unchanged after the period of time, (a) the period of each frame is increased, (b) the number of activity periods of each control signal is unchanged, and (c) the activity periods of each control signal are evenly distributed in each frame so that the length of activity period of each control signal is increased.

11. The driving method as recited in claim 1, wherein:
said processor further outputs a plurality of control signals to a gate driver; and
when the reference percentage or more of the plurality of data voltages are unchanged after the period of time, (a) the period of each frame is increased, (b) the number of activity periods of each control signal during one frame is unchanged, (c) the length of activity period of each control signal is unchanged, and (d) after all the activity periods during one frame are completed the control signals are kept inactive until the end of the frame for each control signal.

12. The driving method as recited in claim 1, wherein the period of time is longer than the period of one frame.

13. The driving method as recited in claim 12, wherein the period of time is from 1 to 5 seconds.

14. A Liquid Crystal Display (LCD), comprising:
a display panel;
a timing controller constructed to output a plurality of control signals; and
a data driver constructed and coupled to receive said plurality of control signals and to output a plurality of data voltages to said display panel via a plurality of data lines, said LCD being configured to display at a constant initial frame rate under a normal operation;
wherein the timing controller is configured to execute an idle detecting step to determine whether an idle event is met or to execute a first manipulation detecting step to determine whether a manipulation event is met, whereby the initial frame rate is decreased to a first frame when a reference percentage or more of the plurality of data voltages are unchanged after a period of time or when a manipulation event occurs resulting in selecting of a specific display mode.

15. The LCD as recited in claim 14, wherein the reference percentage is defined as 50% or more of the plurality of data voltages.

16. The LCD as recited in claim 14, wherein, after the initial frame rate is decreased to the first frame by said timing controller, the idle detecting step is performed again by said timing controller to determine whether the idle event is met, whereby:
when the reference percentage or more of the plurality of data voltages are unchanged after the period of time, the first frame rate is decreased to a second frame rate; and
when the reference percentage or more of the plurality of data voltages are changed after the period of time, the first frame rate is increased to the initial frame rate.

17. The LCD as recited in claim 16, wherein the second frame rate is smaller than the first frame rate.

18. The LCD as recited in claim 16, wherein the second frame rate is larger than the first frame rate.

19. The LCD as recited in claim 16, wherein the second frame rate is equal to the first frame rate.

20. The LCD as recited in claim 19, wherein the first frame rate and the second frame rate have a lower limit value that is the minimal required value for the LCD to operate free of flicker.

21. The LCD as recited in claim 14, wherein, after the frame rate is decreased to the first frame rate by said timing controller, a second manipulation detecting step is performed by said timing controller to determine whether a manipulation event is met, whereby when the manipulation event is met the first frame rate is recovered to the initial frame rate or decreased to a second frame rate according to the manipulation event, with the second frame rate being larger than, smaller than, or equal to the first frame rate.

22. The LCD as recited in claim 14, whereby, when the manipulation event is not met the idle detecting step is performed again by said timing controller, characterized in that:
when the reference percentage or more of the plurality of data voltages are unchanged after the period of time, the first frame rate is decreased to the second frame rate; and
when the reference percentage or more of the plurality of data voltages are changed after the period of time, the first frame rate is increased to the initial frame rate.
